(19) United States
(12) Patent Application Publication
(10) Pub. No.: US 2013/0188459 A1
(43) Pub. Date: Jul. 25, 2013

(54) DOWNHOLE HETERODYNED ECCENTRIC VIBRATOR

(71) Applicants: Peter M. EICK, Houston, TX (US); Joel D. BREWER, Houston, TX (US)

(72) Inventors: Peter M. EICK, Houston, TX (US); Joel D. BREWER, Houston, TX (US)

(73) Assignee: CONOCOPHILLIPS COMPANY, Houston, TX (US)

(21) Appl. No.: 13/717,843

(22) Filed: Dec. 18, 2012

Related U.S. Application Data
(60) Provisional application No. 61/578,442, filed on Dec. 21, 2011.

(51) Int. Cl. G01V 1/153

(52) U.S. Cl. CPC G01V 1/153
USPC 367/189

(57) ABSTRACT

The invention relates to delivering seismic energy with rotating eccentrics where the eccentrics are driven at relatively high, but different rotational rates create a heterodyned frequency of seismic energy into the earth from a downhole location. The rotating eccentrics may be rotated in opposite directions to deliver pressure waves or in the same direction to create a shear component to the seismic impulses.

### CROSS-REFERENCE TO RELATED APPLICATIONS

This application is a non-provisional application which claims benefit under 35 USC §119(e) to U.S. Provisional Application Ser. No. 61/578,442 filed Dec. 21, 2011, entitled “Downhole Heterodyned Eccentric Vibrator,” which is incorporated herein in its entirety.

### STATEMENT REGARDING FEDERALLY SPONSORED RESEARCH

None.

### FIELD OF THE INVENTION

This invention relates to seismic prospecting and especially to technology for delivering seismic energy into the earth in search of hydrocarbon resources.

### BACKGROUND OF THE INVENTION

In the process of acquiring seismic data, seismic energy has long been delivered into the earth from the surface. Various efforts have been undertaken to deliver seismic energy from sources that are situated in boreholes deep in the earth. The issues and concerns and shortcomings that arise with surface located sources are similar for downhole sources with additional complications of delivering energy with a small tool remote from the surface. Over the years, the preferred attributes of the seismic energy delivered into the earth have been honed to include a broad spectrum of wavelengths and sufficient power across the spectrum to be recorded at the surface. In general, a suitable source must be able to deliver seismic energy waves in a spectrum of wavelengths from about 4 Hz up to 60-80 Hz. Higher frequency energy is typically attenuated by transiting the surface. For downhole tools, it is reasonable to want to put seismic energy up to at least 120 Hz and may as high as 250 Hz. However, the source must have sufficient power across the spectrum so that the seismic waves have measurable amplitude at the receiver after transiting through the formation, reflecting from or refracting through layers in the earth. Typically receivers are at the surface and may be located in downhole locations when a survey also inserts sources downhole. In a downhole to downhole survey, it is not a concern whether the seismic energy is able to transit back to the surface. In a downhole to surface survey, the seismic energy only has to transit the surface weathered layer once, where seismic energy is generally the most attenuated. A last major characteristic of a desirable seismic source is that the energy from the source is distinguishable in the data record from seismic energy from other sources whether from background sources or other seismic prospecting.

Explosive charges have long been used as seismic sources although the intense release of energy is typically not permitted except in remote locations. Explosive sources, however, provide a wide array of wavelengths with considerable power across the wavelengths. At the same time, explosives are difficult to use in a downhole environment also given that the source may fracture the well bore and compromise well integrity.

Hydraulic reciprocating seismic vibrators or vibes have been in use for many years using a baseplate connected to hydraulic rams that cause a reaction mass to reciprocate up and down to shake the ground through the baseplate. The hydraulic rams are operated to move the reaction mass through a sweep of the desired frequencies. However, the hydraulic systems are limited in their ability to provide sufficient power at high frequencies due to limitations of hydraulic flow in and out of the hydraulic cylinders. At very high hydraulic velocities, the hydraulic fluid is subject to cavitation when reversing directions that limits the amplitude of the movement of the reaction mass and thus the energy input in to the earth. At low frequencies it is difficult for the hydraulic vibe to have enough travel to generate a low frequency wave into the ground. For example, consider how one would generate a one Hz wave with a hydraulic vibe. A very long throw of the reaction mass is needed to generate that wavelet because the mass has to be moving down and up the full one second.

### BRIEF SUMMARY OF THE DISCLOSURE

The invention more particularly relates to a process for delivering seismic energy into the ground wherein a vibrator tool is inserted into a predrilled borehole and positioning the tool into firm contact with the wall of the borehole. A plurality of eccentric impulse devices within the vibrator tool are rotated to impart impulses into the earth wherein the rotation of the eccentric impulse devices is controlled to heterodyne the impulse that each eccentric impulse device and effectively impart a more powerful impulse into the earth. A returning wavefield of seismic energy returning from the subsurface is sensed and recorded for subsequent analysis.

### BRIEF DESCRIPTION OF THE DRAWINGS

A more complete understanding of the present invention and benefits thereof may be acquired by referring to the follow description taken in conjunction with the accompanying drawings in which:

FIG. 1 is a perspective fragmentary view of an inventive eccentric impulse seismic sweep vibrator tool for use in a borehole;

FIG. 2 is a perspective fragmentary view of a second embodiment of inventive eccentric impulse seismic sweep vibrator tool for use in a borehole;

FIG. 3 is a perspective cut away view of and alternative embodiment of the roller body showing the eccentric mass in its neutral position and deployed into a retracted or extended position to increase the effective eccentricity of the roller body while rotating.

FIG. 4 is a perspective fragmentary view of a second embodiment of inventive eccentric impulse seismic sweep vibrator tool for use in a borehole wherein an additional pair of eccentric impulse devices are included that are positioned in a different orientation with respect to the first pair.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

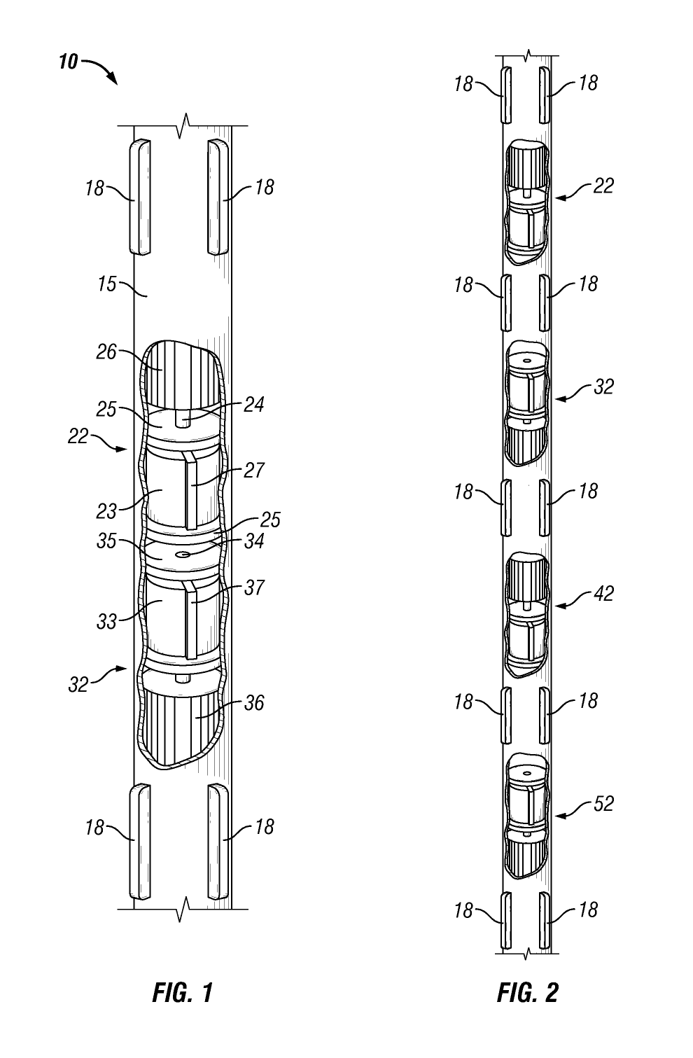

As shown in FIG. 1, a downhole vibrator tool is generally indicated by the numeral 10. The vibrator tool 10 includes a cylindrical body 15 sized to be inserted into a borehole (not shown) from a conventional wireline truck (not shown). When inserted into a borehole, pads 18 are deployed to provide firm contact with the inside wall of the borehole so that vibrations created by the vibrator tool 10 are transmitted into the earth around the borehole. It should be noted that the pads 18 may orient the tool 10 to be centered along the centerline of the borehole or may be used to deliberately arrange the tool 20 to be offset relative to the centerline and therefore may create eccentrically delivered seismic signal in the borehole and to the earth.

The vibrations are created by first and second eccentric impulse devices 22 and 32 mounted inside the vibrator tool 10. The first eccentric impulse device 22 includes a roller body 23 that is mounted for rotation about shaft 24 that is supported within the tool 10 by plates 25. Plates 25 each include robust, but conventional roller type or thrust type bearings to permit roller body 23 to rotate freely about the shaft 24, regardless or the orientation of the shaft. Vibrational input drive 26 is also mounted within the tool 10 and provides rotational force to turn the roller body 23 at rotational speeds that may be fairly precisely controlled. Vibrational input drive 26 may be hydraulic or electric or powered by other controllable power technology. Adjacent to the first eccentric impulse device 22 is a second eccentric impulse device 32 having similar construction. In particular, second eccentric impulse device 32 includes a roller body 33 that is mounted for rotation about shaft 34 and supported within the tool 10 by plates 35. Thrust or roller bearings to permit roller body 33 to rotate freely about the shaft 34 are coaxial to shaft 24. Also, a vibrational input drive 36 is mounted within tool 10 and attached to the shaft 34 and provide rotational force to turn the roller body 33 at rotational speeds that are also fairly precisely controlled. The respective vibrational input drives 26 and 36 may rotate in opposite directions or the same direction depending on the seismic waves intended to be put into the ground.

Each of the roller bodies 23 and 33 include an eccentric mass identified by the number 27 on roller body 23 and as eccentric mass 37 on roller body 33. Eccentric masses 27 and 37 are preferably a highly dense material such as depleted uranium or tungsten to provide roller bodies 23 and 33 with a center of mass that is not coaxial with the respective roller body 23 or 33. As the roller body 23 and 33 rotates around its respective axis or shaft, 24 and 34, respectively, each provides a vibration that is dependent on the mass of the roller bodies 23 and 33, the distance the center of the mass for each roller body 23 and 33 from the respective shaft 24 and 34 and the speed at which the roller body 23 and 33 is rotated about its respective shaft 24 and 34.

Each eccentric impulse device 22 or 32, while rotating will provide a base vibrational frequency. However, while both are rotating, and especially while rotating at different rotational speeds or rates, the two eccentric impulse devices 22 and 32 will also provide compounding frequencies based on heterodyning where the frequencies may be added or subtracted from one another. Thus, four frequencies will be emitted, and all frequencies may be recognized by seismic recording systems. The heterodyned subtraction frequencies that are created by fairly high rotational speeds are interesting from a seismic prospecting standpoint in that high speeds provide high energy levels of seismic energy but frequencies that are relevant to seismic surveying. Such high energy frequencies may be useful for seismic hydrocarbon prospecting. Operating a single eccentric device at the low frequencies of interest using the roller body of the same size as roller body 23 and using a vibrational input drive the same size as vibrational input drive 26 would not provide sufficient energy to be useful in the data record of a seismic recording system. A much, much larger eccentric impulse device that would be impractical to take into the field or position into a borehole. Heterodyning a pair of simple eccentric impulse devices 22 and 32 provides a practical and low cost method for delivering seismic energy to the ground from a downhole location for seismic hydrocarbon prospecting. By varying the rotation speed of eccentric impulse device 32 relative to the other eccentric impulse device 22, one can vary the frequency of the heterodyned output wave. This allows one to create a controllable sweep with relative ease in a downhole environment.

As shown in FIG. 2, it may be that an additional pair of eccentric impulse devices 42 and 52 may be desired. All four eccentric impulse devices are envisioned to work together where two impulse devices would be of similar size, shape and power and would rotate at the same relative speed throughout the seismic sweep while the other two operated also at the same relative speed between the second two, but at a different speed than the first two to create at heterodyne frequency sweep from near DC up to about 250 Hz over a period of about 10 seconds to many minutes.

In a manner similar to the first two embodiments, additional pairs of eccentric impulse devices may be added.

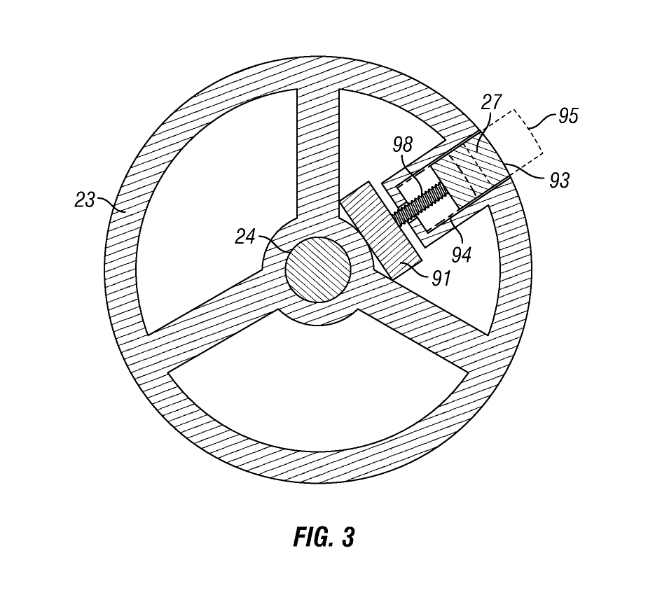

Turning to FIG. 3, in one alternative embodiment, the eccentric mass 27 may be arranged to move relative to the roller body 23 while in motion to alter the eccentricity of the roller body 23. For example, an electric step motor 91 is mounted within the roller body to maintain the eccentric mass at a first position 93 which creates very low eccentricity of the roller body 23. As the vibrational input drive 26 rotates the roller body 23 up to a desired first rotational rate, very little seismic energy is emitted by the eccentric impulse device. Power may be provided to the step motor to change the position of the eccentric mass 27 to either pull in closer to the axis at position 94 or move further away from the axis to position 95 to create higher eccentricity. This adjustment by be done by either internal stepper motors or via a clutch type mechanism using internal hydraulics to control the motion of the eccentric weight. At the first rotational speed, seismic energy would then be emitted into the ground. The vibrational input drive 26 would progressively alter the rotational speed of the roller body 23 with respect to the rotational speed of the other of the heterodyned pair of eccentric impulse devices 22. After a pre-set course of rotational speed progressions, the stepper motor or a clutch type mechanism is then provided the signal and power to recall the eccentric mass 27 to its neutral position 93 while the roller mass is slowed to a stop. It should be understood that multiple sweeps of seismic energy may be emitted while the vibe 10 is at one source point and the roller mass 23 may be kept rotating at a high speed in anticipation of a second or subsequent sweep of seismic energy broadcasting. Eventually, the roller bodies 22 and 32 and others as appropriate will be stopped for the baseplate 20 to be lifted from the ground and for the vibe 10 to move to another source location for further seismic prospecting.

The preferred frequency range of the sweep is from about 1 Hz up to about 500 Hz. High frequencies may vary from survey to survey but are generally at least 80 Hz and commonly up to 120 Hz for surface detectors. In a fully downhole environment, the high end frequency is commonly over 250 Hz but normally less than 500 Hz. Low frequencies may vary from survey to survey but in general they are at least down to 4 Hz and commonly down to 2 Hz.

The vibrator 10 includes electronic circuitry to control the vibration input drives 26 and 36 so that eccentric impulse devices 22 and 32 operate in conjunction with one another to provide combined vibrational power through the baseplate 10 in a heterodyne fashion.

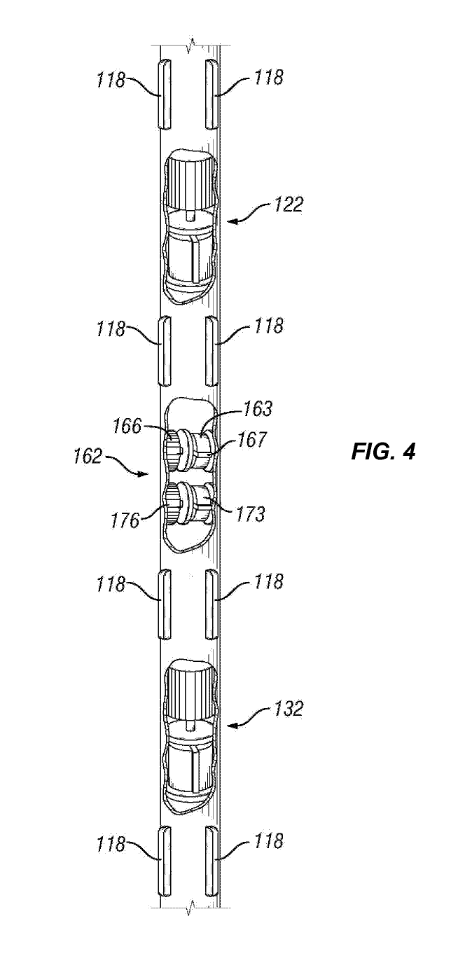

With the arrangement shown in FIGS. 1 and 2, the seismic energy will primarily comprise pressure waves or p-waves. However, it is envisioned that a pair of transverse eccentric impulse devices may be arranged to provide a shear wave component or s-waves into the earth as shown in FIG. 4. With minimal tuning, counter rotating eccentric impulse devices cancel shear waves and magnify the p-waves. However, there are surveys which shear waves provide helpful data. Thus, a pair of transverse mounted eccentric impulse devices 162 are shown where vibrational input drive 166 and 176 rotates the roller bodies 163 and 173 up to a desired first rotational rate. Operationally, this pair of transverse mounted eccentric impulse devices 163 may be controlled in a similar fashion as the vertically oriented pairs to create various wave forms and signal types. Also, it should be recognized that there are many options for setting the orientation of pairs of eccentric impulse devices. With multiple pairs and various orientations, there will be many options for creating wave signals. The heterodyned output signal may be a cross line shear wave, an inline shear wave or a front to back motion. The heterodyned output signal may also create a rocking or bending motion.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for delivering seismic energy into the ground comprising:
a) inserting a vibrator tool into a predrilled borehole and providing the tool into firm contact with the wall of the borehole;
b) rotating a plurality of eccentric impulse devices within the vibrator tool to impart impulses into the earth;
c) controlling the rotation of the eccentric impulse devices to heterodyne the impulse that each eccentric impulse device and effectively impart a more powerful impulse into the earth; and
d) sensing a returning wavefield of seismic energy returning from the subsurface and recording the sensed vibrations for subsequent analysis.

2. The process for delivering seismic energy into the ground according to claim 1, wherein each eccentric impulse device includes a shaft with a weighted rotational element wherein the rotational element includes an eccentric weight that is adjustable while rotating to alter the eccentric impulse delivered to the earth.

3. The process for delivering seismic energy into the ground according to claim 2, wherein each eccentric impulse device includes a vibrational input drive to provide rotational power to the eccentric impulse device.

4. The process for delivering seismic energy into the ground according to claim 3, wherein the heterodyned output signal is a cross line shear wave.

5. The process for delivering seismic energy into the ground according to claim 3, wherein the heterodyned output signal is a inline shear wave or a front to back motion.

6. The process for delivering seismic energy into the ground according to claim 3, wherein the heterodyned output signal is a rocking or bending motion.

7. The process for delivering seismic energy into the ground according to claim 1, wherein the heterodyned output signal is controlled to create a frequency sweep through a range of frequencies.

8. A process for delivering seismic energy into the ground comprising:
a) inserting a vibrator tool into a predrilled borehole and providing the tool into firm contact with the wall of the borehole;
b) rotating a plurality of eccentric impulse devices within the vibrator tool to impart impulses into the earth;
c) controlling the rotation of the eccentric impulse devices to heterodyne the impulse that each eccentric impulse device and effectively impart a more powerful impulse into the earth; and
d) sensing a returning wavefield of seismic energy returning from the subsurface and recording the sensed vibrations for subsequent analysis.

9. The process for delivering seismic energy into the ground according to claim 1, wherein each eccentric impulse device includes a shaft with a weighted rotational element wherein the rotational element includes an eccentric weight that is adjustable while rotating to alter the eccentric impulse delivered to the earth.

10. The process for delivering seismic energy into the ground according to claim 2, wherein each eccentric impulse device includes a vibrational input drive to provide rotational power to the eccentric impulse device.

11. The process for delivering seismic energy into the ground according to claim 3, wherein the heterodyned output signal is a cross line shear wave.

12. The process for delivering seismic energy into the ground according to claim 3, wherein the heterodyned output signal is a inline shear wave or a front to back motion.

13. The process for delivering seismic energy into the ground according to claim 3, wherein the heterodyned output signal is a rocking or bending motion.

14. The process for delivering seismic energy into the ground according to claim 1, wherein the heterodyned output signal is controlled to create a frequency sweep through a range of frequencies.
